(19) United States
(12) Patent Application Publication
(10) Pub. No.: US 2012/0128925 A1
(43) Pub. Date: May 24, 2012

(54) T-Molding

(76) Inventor: Harry V. Empting, JR., Lake City, TN (US)

(21) Appl. No.: 13/361,709

(22) Filed: Jan. 30, 2012

Related U.S. Application Data
(63) Continuation-in-part of application No. 12/399,229, filed on Mar. 6, 2009.

(51) Int. Cl. B32B 3/06

(52) U.S. Cl. 428/100

(57) ABSTRACT

A T-molding to use on an edge of composite wood furniture comprises an underlayer fabricated from an extruded rubber-modified polyolefin blended with an antioxidant, and an outer coating substantially covering the outboard surface of the underlayer, with the outer coating being formed from an acrylic material. Often, the underlayer is flame-treated.

### CROSS-REFERENCE TO RELATED APPLICATIONS

This application is a continuation-in-part of U.S. Utility patent application Ser. No. 12/399,229, filed Mar. 6, 2009.

### STATEMENT REGARDING FEDERALLY SPONSORED RESEARCH OR DEVELOPMENT

Not Applicable

### BACKGROUND OF THE INVENTION

1. Field of Invention

This invention pertains to T-molding edge banding for wood or wood composite furniture. More particularly, this invention pertains to a T-molding edge comprising an extrusion of a rubber modified polypropylene blended with an antioxidant and coated with an ultraviolet-light-cured acrylic material.

2. Description of the Related Art

T-molding is used as a protective and decorative covering for the edge of composite board or plywood, which has a decorative top surface, such as Formica, for example. This type of construction is very often used in the production of office furniture. The T-Molding is secured to the board by slotting the edge of the board then hammering or pushing the barb of the T-Molding into the slot.

In the past, T-molding has commonly been formed from flexible poly-vinyl chlorine (PVC). PVC has good abrasion resistance and trims easily. More importantly, PVC is dangerous to the environment because, if burned, it decomposes to release chlorine gas, a dangerous chemical. Additionally, flexible PVC continuously emits carcinogenic plasticizers into the environment.

### BRIEF SUMMARY OF THE INVENTION

Disclosed herein are varieties and example embodiments of a general inventive concept that comprises a green T-molding edge banding primarily to use on an edge of composite wood furniture. A T-molding fabricated according to the present general inventive concept is typically “green” or environmentally friendly in that it generally avoids the use in its manufacture, for example, of materials like PVC and plasticizers. In several example embodiments of the general inventive concept, a T-molding comprises an underlayer fabricated from a rubber-modified polyolefin blended with an antioxidant and an outer coating substantially covering the outboard surface of said underlayer. Generally, the underlayer comprises a strip of material with an inboard face and an outboard face, with the underlayer having a barb to fit in a groove in the edge of composite wood furniture; this barb protrudes from the inboard face of the strip of material from a position near the center of the strip of material. The strip of material and the barb comprise a single formed piece. In many embodiments, the underlayer is flame-treated.

The T-molding edge banding according to the present general inventive concept, generally combining a thermoplastic olefin core layer with a protective acrylic top coating, in many embodiments exhibits physical properties comparable or superior to PVC-based T-molding, without many of the environmentally hazardous side effects associated with PVC. In particular, a T-molding fabricated according to the present general inventive concept is typically green or environmentally friendly in that its manufacture generally avoids the use, for example, of plasticizers and of halogen-containing materials like PVC. Indeed, T-molding fabricated according to the present general inventive concept is capable of serving as a green substitute for PVC T-molding.

In some example embodiments of the present general inventive concept, a T-molding to use on an edge of composite wood furniture comprises an underlayer fabricated from a polyolefin blended with an antioxidant, said underlayer comprising a strip of material with an inboard face and an outboard face, said underlayer having a barb to fit in a groove in the edge of composite wood furniture, said strip of material and said barb comprising a single formed piece; and a coating of acrylic material substantially covering the outboard surface of said underlayer. In some embodiments, the underlayer includes a modified polyolefin. In some embodiments, the underlayer includes a rubber-modified polyolefin.

The present general inventive concept generally embraces a number of T-moldings that combine a resilient, elastomeric olefin core layer with a top layer or a top coat that combine to provide superior physical properties. A T-molding according to the general inventive concept generally exhibits high temperature stability, great “barb memory,” and high resistance to abrasion compared to competing T-molding edge bandings, including PVC-based T-moldings. T-moldings produced from thermoplastic olefins according to the present invention generally are temperature stable compared to many competing T-molding edge bandings, and they have a stiffness that is minimally affected by changes in ambient temperature. Many T-moldings according to the present invention generally have better spring tension than competing T-molding and will hold a shape in the face of deformative pressures better than competing T-molding. T-moldings according to the present invention show good resistance to abrasion and marring compared to PVC-based T-moldings. Fundamentally, T-moldings according to the present invention, compared to PVC-based T-molding, are better able to hold tight against the edge of a table top. Additionally, a T-molding fabricated according to the present general inventive concept is typically green or environmentally friendly in that its manufacture generally avoids the use, for example, of plasticizers and of halogen-containing materials like PVC.

### BRIEF DESCRIPTION OF THE DRAWINGS

The above-mentioned and additional features of the invention will become more clearly understood from the following detailed description of the invention read together with the drawings in which:

FIG. 1 is a perspective view of one example embodiment of a T-molding edge banding according to one embodiment of the present general inventive;

FIG. 2 is a close-up view of the embodiment shown in FIG. 1; and

FIG. 3 is view of the T-molding shown in FIG. 1 being applied to the edge of a table top.

### DETAILED DESCRIPTION OF THE INVENTION

The present general inventive concept, in some of its several embodiments, comprises a T-molding edge banding primarily for use on an edge of composite wood furniture, wherein the T-molding comprises a flame-treated underlayer that includes a blend of a polyolefin material with an antioxidant, and an outer layer comprising an acrylic material. In some embodiments, the underlayer comprises a rubber-modified polypropylene. In some embodiments, the outer layer comprises an acrylic material cured by ultra-violet light. Generally, T-molding according to the present general inventive concept, in many embodiments, is fabricated by extruding the underlayer, treating it with a flame, and adhering the outer layer to the underlayer.

According to one embodiment of the present invention, T-molding comprises an extrusion of a rubber-modified polypropylene blended with an antioxidant and coated with an ultraviolet-light-cured acrylic.

In one example embodiment of the present general inventive concept, T-molding comprises a flame treated under layer comprising a blend of a polyolefin with an antioxidant and an outer layer secured to said under layer and comprising an acrylic is disclosed.

In one embodiment, the antioxidant is selected from products sold under the trade name of Ciba 225 and Ciba FS301. CIBA 225 allows color pinking, therefore it is replaced with CIBA FS 301. The antioxidant is blended with a polyolefin, preferably a rubber modified polypropylene, such as Santo Prene-Sarlink available from DSM Elastomers.

The under layer is flame-treated.

An outer layer comprising an acrylic, preferably an ultraviolet light cured acrylic, is applied onto the flame-treated under layer.

As discussed hereinabove, the exposed outer layer provides improved abrasion resistance.

In one example embodiment of the present general inventive concept, a polymer-based T-molding, to use on an edge of composite wood furniture, comprises an extrusion of a rubber modified polypropylene blended with an antioxidant and coated with an ultraviolet-light-cured acrylic. In some example embodiments of the present general inventive concept, a T-molding to use on an edge of composite wood furniture comprises an underlayer fabricated from a rubber-modified polyolefin blended with an antioxidant, said underlayer comprising a strip of material with an inboard face and an outboard face, said underlayer having a barb to fit in a groove in the edge of composite wood furniture, said barb protruding from the inboard face of the strip of material from a position near the center of the strip of material, said strip of material and said barb comprising a single formed piece, said underlayer being flame-treated; and an outer coating substantially covering the outboard surface of said underlayer, said outer coating being formed from an acrylic material. In some example embodiments, the underlayer includes a modified thermoplastic polyolefin. In some example embodiments, the underlayer includes a rubber-modified polypropylene. In some example embodiments, the underlayer includes modified polyethylene. In some example embodiments, the underlayer includes a mixture of modified polypropylene and modified polyethylene. In some example embodiments, the outer coating includes an acrylic material cured by ultraviolet light. In some example embodiments, the outer coating includes urethane, polyurethane, an acrylic material, or an epoxy material.

In some example embodiments of the present general inventive concept, a T-molding to use on an edge of composite wood furniture comprises an underlayer fabricated from a modified polyolefin blended with an antioxidant, said underlayer comprising a strip of material with an inboard face and an outboard face, said underlayer having a barb to fit in a groove in the edge of composite wood furniture, said strip of material and said barb comprising a single formed piece; and a coating of acrylic material substantially covering the outboard surface of said underlayer. In some embodiments, the underlayer includes a modified polyolefin. In some embodiments, the underlayer includes a rubber-modified polyolefin. In some embodiments, the underlayer includes a modified thermoplastic olefin. In some embodiments, the underlayer includes a rubber-modified polypropylene. In some embodiments, the underlayer includes modified polyethylene. In some embodiments, the underlayer includes a mixture of modified polypropylene and modified polyethylene. In some embodiments, the coating includes an acrylic material cured by ultraviolet light. In some embodiments, the coating includes urethane, polyurethane, or an epoxy material.

The present general inventive concept provides a durable T-molding that exhibits good temperature stability, great “barb memory,” and high resistance to abrasion compared to competing T-molding edge bandings, including PVC-based T-moldings. Additionally, a T-molding fabricated according to the present general inventive concept is typically “green” or environmentally friendly in that it generally avoids the use, for example, of halogen-containing materials like PVC in its manufacture.

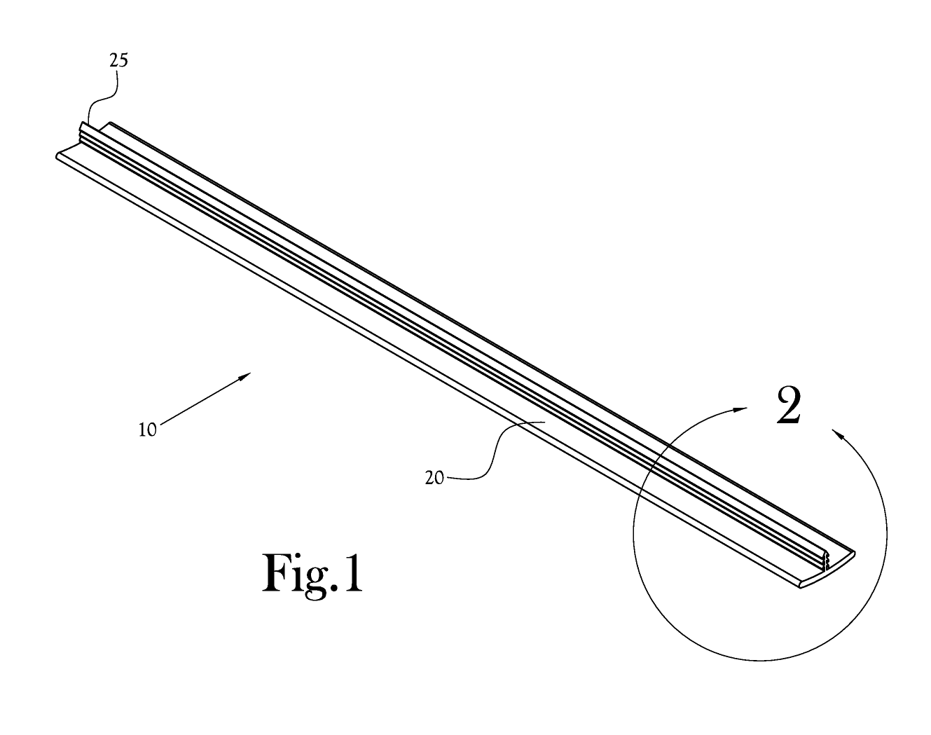

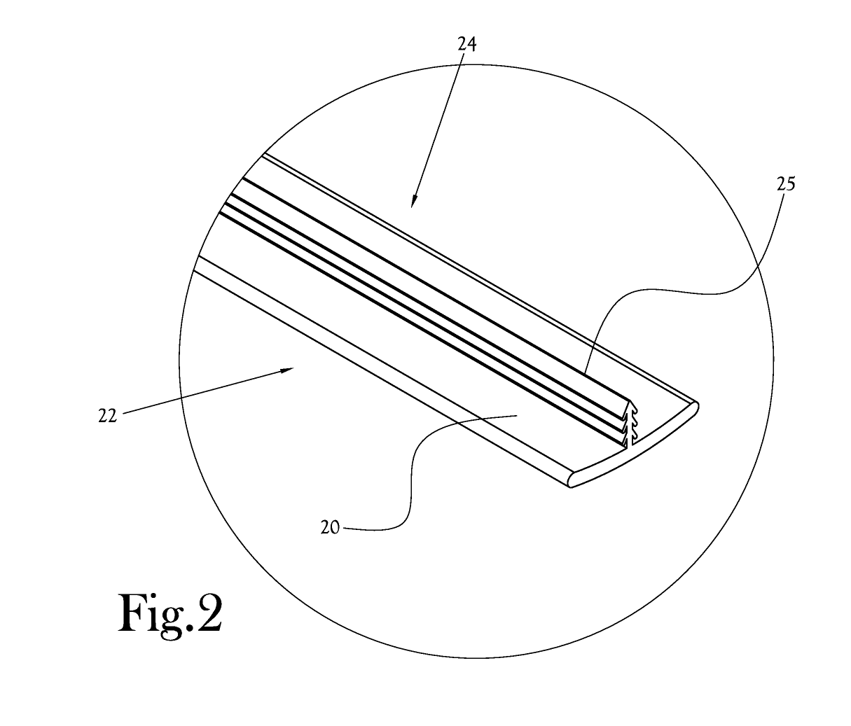

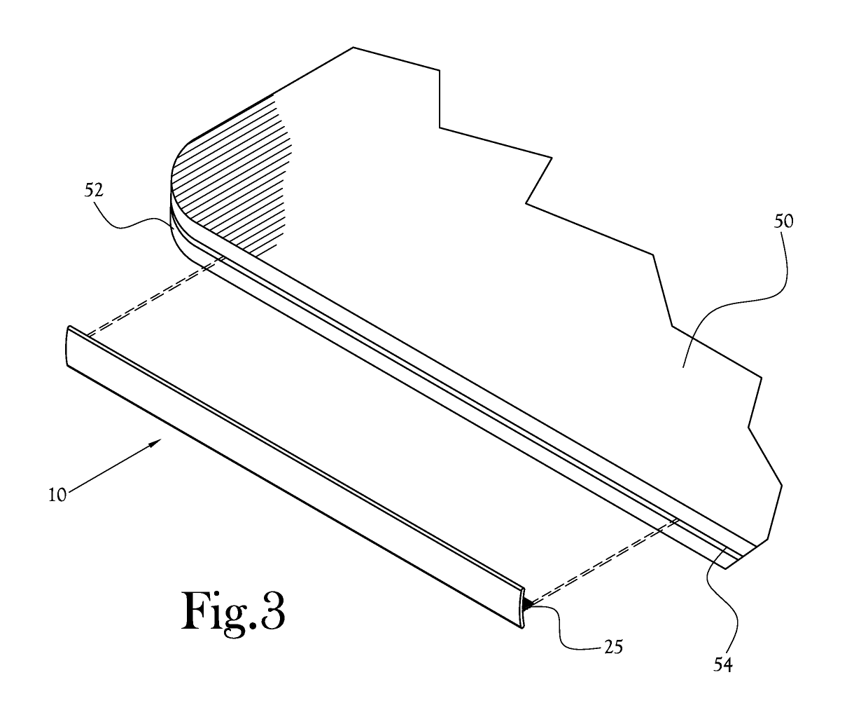

One example embodiment of a T-molding edge banding according to the present general inventive concept is illustrated generally at FIG. 1. As shown in FIG. 1 and in the close-up view the same example embodiment in FIG. 2, the T-molding 10 generally includes a long core strip (or core layer) 20 of modified thermoplastic olefin material (or other core material) comprising the core layer body. In FIG. 1, the T-molding 10 is shown so that the inboard face of the core strip 20 is facing upwards. A barbed mounting strip or simply “barb” 25 protrudes outward from the inboard face of the core strip 20 and extends lengthwise down the center of the inboard face of the core strip 20, approximately equidistant from either lengthwise edge 22 and 24 of the core strip 20. Generally, as shown in FIG. 3, the T-molding 10 is mounted to the edge 52 of a table top 50 by pressing the inboard face of the core strip 20 against the edge 52 of a table top 50 and inserting the barb 25 into a prepared or preformed mounting groove 54 in the edge 52. Often, the mounting groove 54 is slightly narrower in width than the thickness of the barb 25, so that the barb 25 fits snugly within the mounting groove 54 after application of the T-molding 10. The barbed sides of the barb 25 help to ensure that the barb 25 engages with the mounting groove 54 of the edge 52 in a close frictional fit that hinders any movement or separation of the T-molding 10 from the table top 50. The modified thermoplastic olefin material that generally comprises the barb 25 and core strip 20 gives the barb 25 superior “memory”—that is, once the barb 25 is inserted into the mounting groove 54, whereby the individual barbed protrusions on the sides of the barb 25 are compressed and flattened against the central axis of the barb 25, the individual barbed protrusions on the sides of the barb 25 show a great tendency to exert pressure against the walls of the mounting groove 54; in other words, compared to barbs made from polypropylene or PVC, a barb 25 fabricated from modified thermoplastic olefin material shows greater resiliency upon compression and a greater tendency to push back against deformative pressure within the mounting groove 54, thereby causing the individual barbed protrusions on the sides of the barb 25 to exert pressure on the walls of the mounting groove 54. In this way, the thermoplastic olefin material that generally comprises the barb 25 gives the barb 25 superior elastic memory and enhances the frictional fit between the barb 25 and the mounting groove 54.

A number of different core materials, including a number of thermoplastic olefins, homopolymers, and polymer blends, are used in various example embodiments of the invention. Examples of core materials used to fabricated the core strip 20 and barb 25 of the T-molding include, but are not limited to, blends of polypropylene and polyethylene; blends of polypropylene, polyethylene, and rubber; blends of polypropylene, polyethylene, and block copolymer polypropylene; blends of polypropylene, polyethylene, block copolymer polypropylene, and a filler material; blends of polypropylene, polyethylene, block copolymer polypropylene, and rubber; blends of polypropylene, polyethylene, block copolymer polypropylene, rubber, and a filler material; blends of polypropylene, polyethylene, block copolymer polypropylene, and ethylene propylene rubber (EPR); blends of polypropylene, polyethylene, block copolymer polypropylene, and ethylene propyl-diene rubber; blends of polypropylene, polyethylene, block copolymer polypropylene, and ethylene-butadiene; blends of polypropylene, polyethylene, block copolymer polypropylene, and ethylene-octene; and blends of polypropylene, polyethylene, block copolymer polypropylene, and styrene-ethylene-butadiene-styrene. Other materials not mentioned in the foregoing list, and other combinations of materials, will be apparent to those of skill in the art as suitable materials for a core material, and these materials and combinations of materials are contemplated and encompassed by the present general inventive concept. It is also to be noted that the formulation of the core material used to fabricate the core strip 20 and barb 25 is adaptable to being adjusted in order to give the resulting T-molding a desired stiffness or modulus.

A top coat applied to the top layer of the T-molding generally is a curable material, and more particularly in several example embodiments is an activator material cured by exposure to ultraviolet light or electron bombardment during the manufacturing process. Examples of curable activator materials used for the top coat 40 include urethane, polyurethane, acrylic materials, a number of solvent-based mixtures, a number of water-based mixtures, and epoxy. Other materials not mentioned in the foregoing list, and other combinations of materials, will be apparent to those of skill in the art as suitable materials for a top coat, and these materials and combinations of materials are contemplated and encompassed by the present general inventive concept.

The present general inventive concept has been illustrated by description of certain example embodiments, and the illustrative example embodiments have been described in considerable detail, but it is not the intention of the applicant to restrict or in any way limit the scope of the appended claims to such detail.

The present general inventive concept generally embraces a number of T-moldings that combine a resilient, elastomeric olefin core layer with a top layer and a top coat that combine to provide superior physical properties. A T-molding according to the general inventive concept generally exhibits high temperature stability, great “barb memory,” and high resistance to abrasion compared to competing T-molding edge bandings, including PVC-based T-moldings. T-moldings according to the present invention generally are temperature stable compared to many competing T-molding edge bandings, and they have a stiffness that is minimally affected by changes in ambient temperature; thus, for example, it is feasible to use one formulation of thermoplastic olefin for the core layer year-round, whereas for PVC-based T-molding edge bandings, the temperature difference between summer and winter can dictate changes in the composition formulation used in the manufacturing process. Many T-moldings according to the present invention generally have better spring tension than other T-moldings will hold a shape in the face of deformative pressures better than competing T-moldings. T-moldings according to the present invention show good resistance to abrasion and marring compared to PVC-based T-moldings. Fundamentally, T-moldings according to the present invention, compared to PVC-based T-molding, are better able to hold tight against the edge of a table top.

Additionally, a T-molding fabricated according to the present general inventive concept is typically more environmentally friendly than a PVC-based T-molding in so far as it generally avoids the use of halogen-containing materials like PVC in its manufacture.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A green T-molding to use on an edge of composite wood furniture, comprising:
an underlayer fabricated from a rubber-modified polyolefin blended with an antioxidant, said underlayer comprising a strip of material with an inboard face and an outboard face, said underlayer having a barb to fit in a groove in the edge of composite wood furniture, said barb protruding from the inboard face of the strip of material from a position near the center of the strip of material, said strip of material and said barb comprising a single formed piece, said underlayer being flame-treated; and
an outer coating substantially covering the outboard surface of said underlayer, said outer coating being formed from an acrylic material.

2. The green T-molding of claim 1 wherein said underlayer includes a thermoplastic polyolefin.

3. The green T-molding of claim 1 wherein said underlayer includes a rubber-modified polypropylene.

4. The green T-molding of claim 1 wherein said underlayer includes polyethylene.

5. The green T-molding of claim 1 wherein said underlayer includes a mixture of polypropylene and polyethylene.

6. The green T-molding of claim 1 wherein said outer coating includes an acrylic material cured by ultraviolet light.

7. The green T-molding of claim 1 wherein said outer coating includes urethane, polyurethane, an acrylic material, or an epoxy material.

8. A green T-molding to use on an edge of composite wood furniture, comprising:
an underlayer fabricated from a polyolefin blended with an antioxidant, said underlayer comprising a strip of material with an inboard face and an outboard face, said underlayer having a barb to fit in a groove in the edge of composite wood furniture, said strip of material and said barb comprising a single formed piece; and
a coating of acrylic material substantially covering the outboard surface of said underlayer.

9. The green T-molding of claim 8 wherein said underlayer includes a modified polyolefin.

10. The green T-molding of claim 8 wherein said underlayer includes a rubber-modified polyolefin.

11. The green T-molding of claim 8 wherein said underlayer includes a thermoplastic olefin.

12. The green T-molding of claim 8 wherein said underlayer includes a rubber-modified polypropylene.

13. The green T-molding of claim 8 wherein said underlayer includes polyethylene.

14. The green T-molding of claim 8 wherein said underlayer includes a mixture of polypropylene and polyethylene.

15. The green T-molding of claim 8 wherein said coating includes an acrylic material cured by ultraviolet light.

16. The green T-molding of claim 8 wherein said coating includes urethane, polyurethane, or an epoxy material.
